(19) United States
(12) Patent Application Publication
(10) Pub. No.: US 2026/0172617 A1
(43) Pub. Date: Jun. 18, 2026

(54) ELECTRONIC DEVICE AND DISPLAY SYSTEM

(71) Applicant: SAMSUNG ELECTRONICS CO., LTD., Suwon-si (KR)

(72) Inventors: Wooseok KANG, Suwon-si (KR); Doohyun KIM, Suwon-si (KR); Minho KIM, Suwon-si (KR); Kiwon YOO, Suwon-si (KR); Bumkwi CHOI, Suwon-si (KR)

(73) Assignee: SAMSUNG ELECTRONICS CO., LTD., Suwon-si (KR)

(21) Appl. No.: 19/364,209

(22) Filed: Oct. 21, 2025

Related U.S. Application Data
(63) Continuation of application No. PCT/KR2025/014555, filed on Sep. 18, 2025.

(30) Foreign Application Priority Data
Dec. 16, 2024 (KR) 10-2024-0187643

(51) Int. Cl. H04N 21/262; H04N 21/472

(52) U.S. Cl. CPC H04N 21/2625; H04N 21/47217

(57) ABSTRACT

An electronic device includes: a communication interface; a display; at least one processor; and memory storing instructions, wherein the instructions, when executed by the at least one processor individually or collectively, cause the electronic device to: obtain, through the communication interface, a series of source frames encoded, each source frame time length of each of the source frames, and first reference point timing information for a first reference point defined on a first source frame among the series of source frames; generate playback frames for reproduction through the display by decoding the source frames; determine a playback delay value based on the first reference point timing information and each source frame time length of each of the source frames corresponding to playback frames that complete playback prior to obtaining the first reference point timing information; and perform delay control based on the playback delay value.

### CROSS-REFERENCE TO RELATED APPLICATIONS

This application is a by-pass continuation application of International Application No. PCT/KR2025/014555, filed on Sep. 18, 2025, which is based on and claims priority to Korean Patent Application No. 10-2024-0187643, filed on Dec. 16, 2024, in the Korean Intellectual Property Office, the disclosures of which are incorporated by reference herein their entireties.

### BACKGROUND

### 1. Field

The disclosure relates to a method for controlling playback delay in multimedia data streaming and an electronic device providing the method.

### 2. Description of Related Art

In widely utilized low-latency streaming technology, multimedia data transmitted from a transmitter through a network is received and simultaneously played back on a display device. The transmitter may encode original multimedia data (initial multimedia data or first multimedia data) to generate a stream of source frames for transmission and transmit the encoded multimedia data to the display device.

The display device may receive and decode the stream of the source frames, and may play back a series of playback frames in the decoded stream of the source frames. To maintain a high level of playback quality, a playback speed of playback frames at the display device should match a speed of the original multimedia data at the transmitter, and a delay of playback frames relative to source frames should be preferably maintained at a target level. However, due to various causes such as jitter between the source clock of the transmitter and the playback clock of the display device, variations in transmission delay time according to network condition changes, variations in processor and system processing speeds of the transmitter and the display device, respectively, delay states of playback frames at the display device may fluctuate significantly over time.

### SUMMARY

To prevent deterioration of multimedia data playback quality, it may be necessary to continuously monitor the delay state, i.e., the variation in delay amount, existing in playback frames at the display device and take appropriate control measures so that the delay amount may be maintained at a target level according to the monitoring results. In particular, a method may be needed to precisely monitor and control variations in playback delay amount even in a case that source frames with variable frame rates determined according to a variable refresh rate (VRR) are received and played back and/or in case source frames with variable lengths according to a variable bit rate (VBR) scheme are received and played back.

The disclosure provides a playback delay amount control method that enables a receiver to monitor playback delay amount in fine time units at the subframe level in relation to streaming of encoded multimedia data source frames and perform operations to maintain the playback delay amount at a target level in a timely manner, and a device supporting such a control method.

According to an aspect of the disclosure, An electronic device includes: a communication interface; a display; at least one processor; and memory storing instructions, wherein the instructions, when executed by the at least one processor individually or collectively, cause the electronic device to: obtain, through the communication interface, a series of source frames encoded, each source frame time length of each of the source frames, and first reference point timing information for a first reference point defined on a first source frame among the series of source frames; generate playback frames for reproduction through the display by decoding the source frames; determine a playback delay value based on the first reference point timing information and each source frame time length of each of the source frames corresponding to playback frames that complete playback prior to obtaining the first reference point timing information; and perform delay control based on the playback delay value.

According to an aspect of the disclosure, a display system includes: a video transmission device including: an encoder configured to encode video information into a series of source frames; a time length generation circuit configured to generate each source frame time length information regarding each of the source frames; a reference point timing information generation circuit configured to generate first reference point timing information corresponding to a first reference point of a first source frame among the series of source frames; and a first communication interface configured to transmit stream data including the series of source frames, each source frame time length information regarding each of the source frames, and the first reference point timing information; a video reception device including: a second communication interface configured to receive the stream data; a decoder configured to generate a series of playback frames from the source frames of the stream data; a display configured to reproduce the series of playback frames; a delay amount determination circuit configured to determine a playback delay value based on the first reference point timing information and each source frame time length of each of the source frames corresponding to playback frames that complete playback by the display prior to obtaining the first reference point timing information; and a delay control circuit configured to perform delay control based on the playback delay value.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a configuration of a multimedia data transmitter according to an embodiment of the disclosure;

FIG. 2 illustrates a configuration of a display device according to an embodiment of the disclosure;

FIG. 3 illustrates functions of a transmitter controller according to an embodiment of the disclosure;

FIG. 4 is a flowchart of transmission data processing of a transmitter according to an embodiment of the disclosure;

FIG. 5 illustrates functions of a receiver controller according to an embodiment of the disclosure;

FIG. 6 illustrates an example case of calculating delay amounts of playback frames relative to source frames performed in a receiver according to an embodiment of the disclosure;

FIG. 7 illustrates an example case of calculating delay amounts of playback frames relative to source frames performed in a receiver according to an embodiment of the disclosure;

FIG. 8 illustrates an example case of calculating delay amounts of playback frames relative to source frames performed in a receiver according to an embodiment of the disclosure;

FIG. 9 illustrates an example case of calculating delay amounts of playback frames relative to source frames performed in a receiver according to an embodiment of the disclosure; and

FIGS. 10A and 10B are flowcharts of data processing of a receiver according to an embodiment of the disclosure.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in various other forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

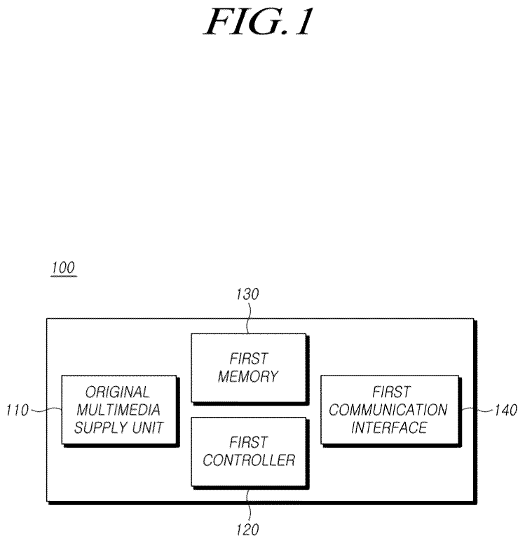

FIG. 1 illustrates a configuration of a multimedia data transmitter according to an embodiment of the disclosure.

According to an embodiment, a transmitter 100 may include an original multimedia supply unit 110, a first controller 120, first memory 130, and a first communication interface 140. The transmitter 100 may include additional components other than the illustrated components, or may omit at least one of the illustrated components.

According to an embodiment, the original multimedia supply unit 110 may receive various multimedia contents from other devices or external servers in a wired or wireless manner. According to an embodiment, the original multimedia supply unit 110 may receive television broadcast content transmitted in a wired or wireless manner, video content received from a video service server, game content received from a game service server or a game device, and/or video content received from various other devices. According to an embodiment, the original multimedia supply unit 110 may process the received multimedia content to generate an original multimedia data stream (an initial multimedia data stream or a first multimedia data stream), and supply the generated original multimedia data stream to the first controller 120.

According to an embodiment, the first controller 120 may be configured to perform overall control operations of the transmitter 100. The first controller 120 may be implemented as a digital signal processor (DSP), a microprocessor, or a time controller (TCON) that processes digital signals. However, without limitations thereto, the controller may include one or more of a central processing unit (CPU), a micro controller unit (MCU), a micro processing unit (MPU), a controller, an application processor (AP), a graphics processing unit (GPU), a communication processor (CP), or an ARM processor, or may be defined by corresponding terms. Further, the first controller 120 may be implemented as a System-on-Chip (SoC) with built-in processing algorithms, large scale integration (LSI), or may be implemented in a form of a field programmable gate array (FPGA). Further, the first controller 120 may perform various functions by executing computer executable instructions stored in the first memory 130. The first controller 120 may be electrically connected to the original multimedia supply unit 110, the first memory 130, and the first communication interface 140.

According to an embodiment, the first memory 130 may be implemented as internal memory such as ROM (e.g., electrically erasable programmable read-only memory (EEPROM)) and RAM included in the first controller 120, or may be implemented as a separate memory from the first controller 120. In this case, the first memory 130 may be implemented in a form of memory in the transmitter 100 or in the form of memory detachable from the transmitter 100 according to data storage purposes. For example, data for driving the transmitter 100 may be stored in memory in the transmitter 100, and data for an extension function of the transmitter 100 may be stored in memory detachable from the transmitter 100.

The memory in the transmitter 100 may be implemented as at least one of, e.g., a volatile memory (e.g., a dynamic RAM (DRAM), a static RAM (SRAM), a synchronous dynamic RAM (SDRAM), etc.) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD). The memory detachable from the transmitter 100 may be implemented as a memory card (e.g., compact flash (CF), secure digital (SD), micro secure digital (micro-SD), mini secure digital (mini-SD), extreme digital (xD), multi-media card (MMC), or the like), an external memory (e.g., USB memory) connectable to a USB port, or the like.

According to an embodiment, the first controller 120 may receive an original multimedia data stream from the original multimedia supply unit 110. The first controller 120 may encode the received original multimedia data stream to generate a series of source frames for transmission. The first controller 120 may generate a series of source frames encoded to have delay and number of bits determined according to encoding options based on characteristics of the original multimedia data, network environment, and/or device specifications. The first controller 120 may generate source clock information regarding each source frame based on the source clock of the transmitter 100. The first controller 120 may transmit the generated source frames together with corresponding source clock information to the first communication interface 140.

According to an embodiment, the first communication interface 140 may transmit/receive various data including multimedia data and various control data to/from a display device 200. According to an embodiment, the first communication interface 140 may transmit the source frames and corresponding source clock information to the outside. According to an embodiment, the first communication interface 140 may also receive information coming from the outside and transmit it (the received information) to the first controller 120. The first communication interface 140 may be implemented with at least one wired communication circuit or wireless communication circuit, and each communication circuit may support a predetermined bandwidth. In some embodiments, the first communication interface 140 may transmit/receive data with the display device 200 using various protocols.

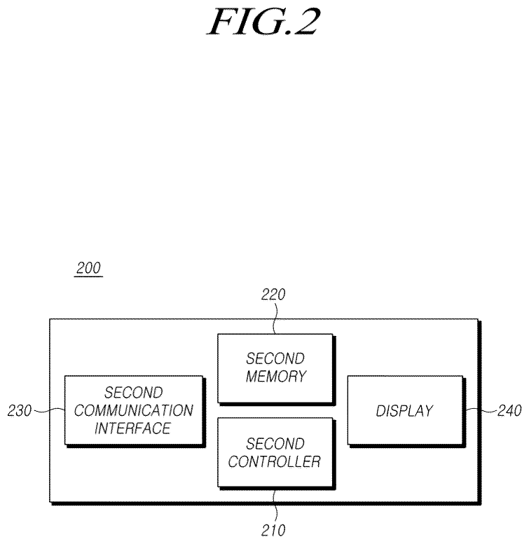

FIG. 2 illustrates a configuration of a display device according to an embodiment of the disclosure.

According to an embodiment, the display device 200 may include a second controller 210, second memory 220, a second communication interface 230, and a display 240. The display device 200 may include additional components in addition to the illustrated components, or may omit at least one of the illustrated components.

According to an embodiment, the second communication interface 230 may receive source frames and source clock information transmitted from the transmitter 100. According to an embodiment, the second communication interface 230 may transmit feedback control data generated in the display device 200 to the transmitter 100. The second communication interface 230 may be implemented with at least one wired communication circuit or wireless communication circuit, and each communication circuit may support a predetermined bandwidth. In some embodiments, the second communication interface 230 may transmit/receive data with the transmitter 100 using various protocols.

According to an embodiment, the second controller 210 may perform overall control operations of the display device 200. The second controller 210 may be implemented as a digital signal processor (DSP), a microprocessor, or a time controller (TCON) that processes digital signals. However, without limitations thereto, the controller may include one or more of a central processing unit (CPU), a micro controller unit (MCU), a micro processing unit (MPU), a controller, an application processor (AP), a graphics processing unit (GPU), a communication processor (CP), or an ARM processor, or may be defined by corresponding terms. Further, the second controller 210 may be implemented as a system on chip (SoC) with built-in processing algorithms, large scale integration (LSI), or may be implemented in the form of a field programmable gate array (FPGA). Further, the second controller 210 may perform various functions by executing computer executable instructions stored in the second memory 220. The second controller 210 may be electrically connected to the second memory 220, the second communication interface 230, and the display 240.

According to an embodiment, the second memory 220 may be implemented as internal memory such as ROM (e.g., electrically erasable programmable read-only memory (EEPROM)) and RAM included in the second controller 210, or may be implemented as a separate memory from the second controller 210. In this case, the second memory 220 may be implemented in a form of memory in the display device 200 or in a form of memory detachable from the display device 200 according to data storage purposes. For example, data for driving the display device 200 may be stored in memory of the display device 200, and data for an extension function of the display device 200 may be stored in memory detachable from the display device 200.

The memory of the display device 200 may be implemented as at least one of, e.g., a volatile memory (e.g., a dynamic RAM (DRAM), a static RAM (SRAM), a synchronous dynamic RAM (SDRAM), etc.) or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash, or a NOR flash), a hard drive, or solid state drive (SSD). The memory detachable from the display device 200 may be implemented as a memory card (e.g., compact flash (CF), secure digital (SD), micro secure digital (micro-SD), mini secure digital (mini-SD), extreme digital (xD), multi-media card (MMC), or the like), an external memory (e.g., USB memory) connectable to a USB port, or the like.

According to an embodiment, the second controller 210 may obtain a series of source frames transmitted from the transmitter 100 and corresponding source clock information through the second communication interface 230. The second controller 210 may decode the received source frames to generate a series of playback frames. The second controller 210 may monitor the delay state of the playback frames relative to the source frames, e.g., the delay amount of decoding and/or playback processing relative to the source frames. The second controller 210 may monitor the delay state of decoding and/or playback processing currently being performed in the display device 200 based on the source clock information regarding the source frames obtained through the second communication interface 230. The second controller 210 may perform necessary delay control operations according to the monitoring results of the delay state.

According to an embodiment, the display 240 may be configured to display an image corresponding to the playback frames generated by the second controller 210. The display 240 may include various types of display panels such as a liquid crystal display (LCD) panel, a light emitting diode (LED) panel, an organic light emitting diode (OLED) panel, and a plasma display panel (PDP), and may include panel driving units for driving the display panel.

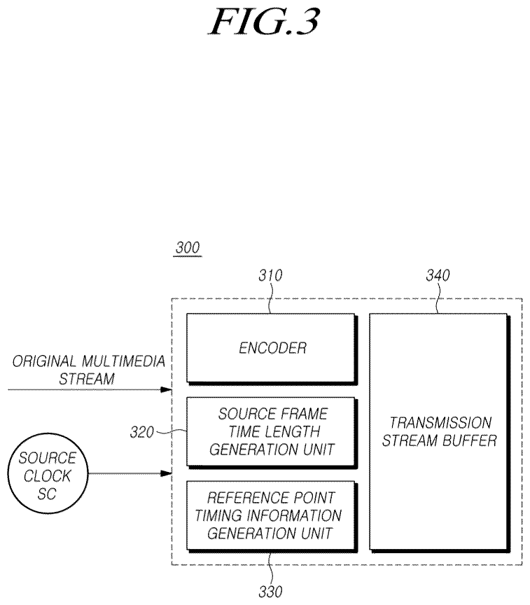

FIG. 3 illustrates functions of a transmitter controller according to an embodiment of the disclosure. According to an embodiment, a transmitter controller 300 may be implemented as at least a portion of the first controller 120 of the transmitter 100 of FIG. 1.

According to an embodiment, the transmitter controller 300 may receive an original multimedia data stream. According to an embodiment, the received original multimedia data stream may include video data. According to an embodiment, the received original multimedia data stream may have a predetermined original speed (e.g., input time interval of each frame of the original multimedia data stream). According to an embodiment, the transmitter controller 300 may obtain source clock information SC. According to an embodiment, the transmitter controller 300 may perform various operations described below based on the obtained source clock information SC.

According to an embodiment, the transmitter controller 300 may include an encoder 310. According to an embodiment, the encoder 310 may receive an original multimedia data stream. According to an embodiment, the encoder 310 may encode the original multimedia data stream into a series of source frames according to the original speed of the original multimedia data stream. According to an embodiment, the encoder 310 may encode the original multimedia data stream into a series of source frames based on various information including characteristics of the original multimedia data stream, network conditions, and/or specifications of related devices.

According to an embodiment, the transmitter controller 300 may include a source frame time length generation unit 320 (or a source frame time length generation circuit). According to an embodiment, the source frame time length generation unit 320 may generate information indicating a source frame time length corresponding to each source frame generated in the above-described encoder 310, e.g., a total number of source clock cycles (v_total_cycle_s) allocated to each source frame. According to an embodiment, the source frame time length (v_total_cycle_s) of a source frame may be the number of total source clock cycles that occurred during the interval from the input of that source frame to the input of the next source frame.

According to an embodiment, the transmitter controller 300 may include a reference point timing information generation unit 330 (or a reference point timing information generation circuit). According to an embodiment, the reference point timing information generation unit 330 may determine one or more time reference points to be disposed in the middle of the source frames generated in the above-described encoder 310 according to predetermined criteria. According to an embodiment, each time reference point disposed in the middle of a series of source frames may be any one time point in the middle of the duration of any one source frame. According to an embodiment, the reference point timing information generation unit 330 may generate each reference point timing information (enc_cycle) respectively corresponding to one or more time reference points disposed in the middle of the source frames.

According to an embodiment, the reference point timing information for any one time reference point may indicate the reference point timing, e.g., the accumulated total number of source clock cycles from the start of the series of source frames to the given time reference point. According to an embodiment, the reference point timing information (“enc_cycle”) for any one time reference point may indicate the accumulated number of source clock cycles from the time reference point immediately before that time reference point (if the reference point is the first reference point of the source frame stream, the immediately preceding reference point may be the starting point of the source frame stream) to that time reference point. According to an embodiment, the reference point timing information for any one time reference point may indicate the number of source clock cycles from the start of the source frame to which the reference point belongs to the reference point. According to various embodiments, the reference point timing information may be determined in various ways that may specify the temporal position of the reference point within the source frames based on various factors such as characteristics of the source frames, device characteristics of transmitter and the receiver, network environment characteristics, etc.

According to an embodiment, the transmitter controller 300 may include a transmission stream buffer 340. According to an embodiment, each source frame generated in the above-described encoder 310, the source frame time length (hereinafter “v_total_cycle_s”) allocated to each source frame generated in the above-described source frame time length generation unit 320, and timing information (enc_cycle) regarding each time reference point generated in the above-described reference point timing information generation unit 330 may be stored in the transmission stream buffer 340. According to an embodiment, the source frames and various time information stored in the transmission stream buffer 340 may be appropriately integrated and processed according to network protocols, and then, delivered to the first communication interface 140 of FIG. 1 for external transmission. According to an embodiment, the transmission stream buffer 340 may process input data in a first-in-first-out manner and deliver it (the processed input data) to the first communication interface 140, but embodiments of the disclosure are not limited thereto.

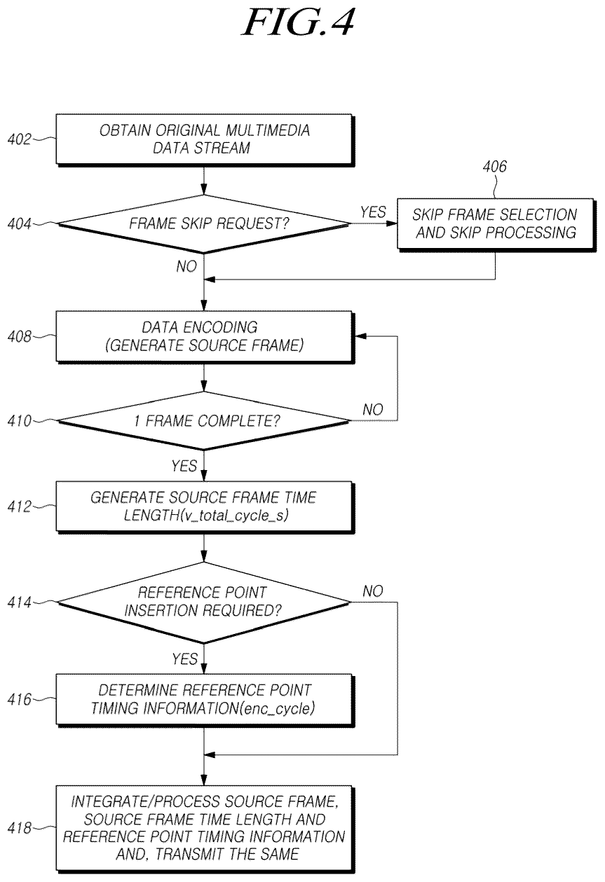

FIG. 4 is a flowchart of transmission data processing of a transmitter according to an embodiment of the disclosure. According to an embodiment, the transmission data processing disclosed in FIG. 4 may be implemented at least partially by the first controller 120 of the transmitter 100 of FIG. 1 and/or the transmitter controller 300 of FIG. 3.

According to an embodiment, in operation 402, an original multimedia data stream (that is, an initial multimedia data stream or a first multimedia data stream) may be obtained. In an embodiment, the original multimedia data may include a stream of data frames generated from various video contents received from the outside of an electronic device. In an example, the original multimedia data stream may have an original speed (e.g., input speed of each data frame of the original multimedia data stream).

In operation 404, it may be determined, for example by at least one processor of an electronic device, whether there is a frame skip request. According to an embodiment, the frame skip request may be information transmitted as feedback information from the display device 200 for playback delay control as described below. According to an embodiment, the frame skip request may be information obtained through the first communication interface 140 of FIG. 1.

If it is determined, for example by at least one processor of an electronic device, in operation 404 that there is a frame skip request, the procedure may proceed to operation 406 to perform processing according to the frame skip request, such as selection of frames to be skipped and skip processing. According to an embodiment, if there is a frame skip request, the transmitter may analyze multimedia data characteristics to determine skippable sections and accordingly extract and skip frames to be skipped. In an embodiment, the transmitter may analyze characteristics of the multimedia data to determine, e.g., scene transition sections, MUTE sections, sections with excessively low image quality, etc. as skippable sections, but embodiments of the disclosure are not limited. In various embodiments, the determination of whether there is a frame skip request and processing according to the skip request may be performed at any various points during the operation process of the transmitter.

In operation 408, an encoding of the original multimedia data stream may be performed. According to an embodiment, the original multimedia data stream may be encoded into a series of source frames according to the original speed of the original multimedia data stream. According to an embodiment, the original multimedia data stream may be encoded into a series of source frames based on various information including characteristics of the original multimedia data stream, network conditions, and/or specifications of related devices. According to an embodiment, various video compression algorithms, e.g., video compression algorithms such as moving picture experts group (MPEG)-4, high efficiency video coding (HEVC), etc. may be used for encoding the original multimedia data stream.

In operation 410, it may be determined, for example by at least one processor of an electronic device, whether generation of one source frame has been completed. In operation 410, if it is determined, for example by at least one processor of an electronic device, that generation of one source frame has been completed, the procedure may proceed to operation 412 in which a source frame time length for the generated source frame may be generated. In an embodiment, e.g., the total number of source clock cycles (v_total_cycle_s) allocated to the generated source frame may be measured and provided as the source frame time length of that frame.

In operation 414, it may be determined, for example by at least one processor of an electronic device, whether it is time to insert a time reference point. Whether it is time to insert a time reference point may be determined according to predetermined criteria. According to an embodiment, the time reference point may be any one time point in the middle of the duration of any source frame among a series of source frames, i.e., any one time point in the middle of the interval between that source frame and the next source frame. According to an embodiment, the time reference point may be inserted periodically or aperiodically according to predetermined criteria to check the delay state that occurs when decoding and playing back the source frames. According to an embodiment, one or more time reference points may be present within each source frame. According to an embodiment, the time reference points may be present one every few source frames. According to an embodiment, the insertion criteria for the time reference points may be adaptively and dynamically determined according to various circumstances including, e.g., a frame rate, a delay management policy, network conditions, original multimedia characteristics, etc., and the disclosure is not limited to specific embodiments.

If it is determined, for example by at least one processor of an electronic device, in operation 414 that a time reference point needs to be inserted, the procedure may proceed to operation 416 to determine reference point timing information (enc_cycle) corresponding to the time reference point. In an embodiment, the reference point timing information (enc_cycle) corresponding to the time reference point may indicate the accumulated number of source clock cycles from the time reference point immediately before the time reference point to the time reference point. In an embodiment, the reference point timing information for any one time reference point on a series of source frames may indicate the accumulated total number of source clock cycles from the starting point of that series of source frames to the given time reference point.

According to an embodiment, the reference point timing information (enc_cycle) for any one time reference point may indicate the accumulated number of source clock cycles from the time reference point immediately before the time reference point to the time reference point. As described above, the reference point timing information for any one time reference point may be determined in any manner determined according to various considerations. In some embodiments, the determination of whether time reference point insertion is necessary and the determination of the reference point timing information may be performed at any various points during the operation process of the transmitter.

In operation 418, the previously generated source frames and control data regarding those source frames, such as the source frame time length corresponding to each source frame and the reference point timing information (enc_cycle) corresponding to each time reference point, may be integrated and processed based on (or according to) predetermined protocols. According to an embodiment, the integrated and processed final information may be transmitted to the outside.

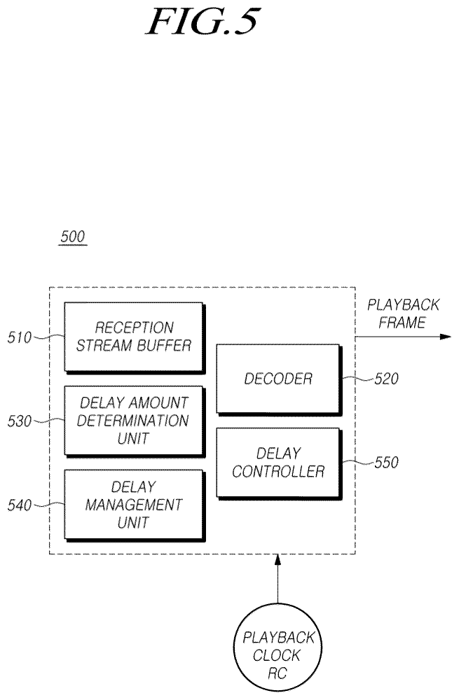

FIG. 5 illustrates functions of a receiver controller according to an embodiment of the disclosure. According to an embodiment, a receiver controller 500 may be implemented as at least a portion of the second controller 210 of the display device 200 of FIG. 1.

According to an embodiment, the receiver controller 500 may be configured to receive data transmitted from a transmitter through a network. According to an embodiment, the receiver controller 500 may receive a stream of source frames and various control data. According to an embodiment, the receiver controller 500 may receive the source frame time length of each source frame transmitted from the transmitter and the reference point timing information of each time reference point. According to an embodiment, the receiver controller 500 may obtain playback clock information RC. According to an embodiment, the receiver controller 500 may perform various operations described below based on the obtained playback clock information RC.

According to an embodiment, the receiver controller 500 may include a reception stream buffer 510. According to an embodiment, the stream of source frames and control data (which may include, e.g., the source frame time length and the reference point timing information of each time reference point) obtained by the receiver controller 500 may be obtained and stored by the reception stream buffer 510.

According to an embodiment, the receiver controller 500 may include a decoder 520. According to an embodiment, the decoder 520 may obtain the source frames and control data (which may include, e.g., the source frame time length and the reference point timing information of each time reference point) from the reception stream buffer 510. According to an embodiment, the decoder 520 may decode the obtained source frames to generate playback frames to be displayed through a display.

According to an embodiment, the decoder 520 may generate the playback frames based on the source frame time length (v_total_cycle_s) corresponding to each source frame. According to an embodiment, the playback frame generated by the decoder 520 may have a playback time length (v_total_cycle_d) determined according to the source frame time length (v_total_cycle_s) of the corresponding source frame. According to an embodiment, the playback time length (v_total_cycle_d) may be the total number of playback clock cycles indicating the output interval of the playback frames generated in the decoder 520. According to an embodiment, the playback frame generated in the decoder 520 may have a playback time length (v_total_cycle_d) of the total number of playback clock cycles determined to be equal to the total number of source clock cycles of the corresponding source frame. According to an embodiment, the playback frame generated in the decoder 520 may have a playback time length (v_total_cycle_d) of the total number of playback clock cycles determined in proportion to the total number of source clock cycles of the corresponding source frame, but embodiments of the disclosure are not limited to specific examples. According to an embodiment, the decoder 520 may generate final playback frame duration information (dec_cycle) indicating the number of playback clock cycles elapsed from the playback start of the most recently decoded playback frame to the time of obtaining the reference point timing information. According to an embodiment, the playback frame generated in the decoder 520 may be delivered to a display for display.

According to an embodiment, the receiver controller 500 may include a delay amount determination unit 530 (or a delay amount determination circuit). According to an embodiment, the delay amount determination unit 530 may obtain the total number of source frames that have been decoded and playback completed by the decoder 520 through the reception stream buffer 510 and the source frame time length (v_total_cycle_s) of each of these source frames. According to an embodiment, the delay amount determination unit 530 may obtain the reference point timing information (enc_cycle) of each time reference point present among a series of source frames. According to an embodiment, the delay amount determination unit 530 may obtain the final playback frame duration information (dec_cycle) generated in the decoder 520.

According to an embodiment, the delay amount determination unit 530 may determine a delay amount (delay_cycle) regarding decoding and playback in the receiver controller 500 whenever the reference point timing information (enc_cycle) of a time reference point is obtained. According to an embodiment, the delay amount determination unit 530 may calculate (or determine) the delay amount by Equation 1 below (where L is the number of frames that have been decoded through the decoder 520 and playback completed, and frames that have been playback repeated are not included here).

$$delay\_cycle = reference point temporal position - ( {\sum }_{l = 0}^{L} v\_total \_cycle \_s [ l ] + dec\_cycle ) \qquad [ Equation l ]$$

In Equation 1 above, the reference point temporal position of the reference point may be the accumulated number of source clock cycles from the start of the source frame stream to the time reference point. According to an embodiment, if the reference point timing information (enc_cycle) transmitted together with the source frames from the transmitter directly indicates the accumulated number of source clock cycles from the starting point of that series of source frames to the given time reference point, the reference point timing information (enc_cycle) may be directly used as the reference point temporal position. Alternatively, according to an embodiment, if the reference point timing information (enc_cycle) transmitted together with the source frames from the transmitter indicates the accumulated number of source clock cycles from the reference point immediately before the given reference point (if the given reference point is the first reference point of the source frame stream, the immediately preceding reference point may be the starting point of the source frame stream) to the given reference point, the reference point temporal position may be obtained by Equation 2 (where M is the number of each reference point timing information obtained up to the given reference point).

$$reference point temporal position = {\sum }_{j = 0}^{M} enc\_cycle [ j ] \qquad [ Equation 2 ]$$

According to an embodiment, if the reference point timing information (enc_cycle) transmitted together with the source frames from the transmitter indicates the number of source clock cycles from the start of the source frame to which the reference point belongs to the given reference point, the reference point temporal position may be obtained by Equation 3 (where N is the number of source frames up to the source frame before the source frame to which the given reference point belongs, and skipped frames are not included here).

$$reference point temporal position = {\sum }_{k = 0}^{N} v\_total \_cycle \_s [ k ] + enc\_cycle \qquad [ Equation 3 ]$$

According to an embodiment, the receiver controller 500 may include a delay management unit 540 (or a delay management circuit). According to an embodiment, the delay management unit 540 may receive the delay amount calculated (or determined) in the delay amount determination unit 530 and compare the delay amount with one or more predetermined parameters. According to an embodiment, the delay management unit 540 may determine whether the current delay state is excessively high or low according to the result of the comparison, and according to the determination result, generate a delay management request necessary to maintain such delay state at an appropriate level.

According to an embodiment, the delay management request that may be generated by the delay management unit 540 may include, e.g., a request to increase/decrease the playback time length of a playback frame relative to the source frame time length regarding a source frame by a predetermined amount or adjust it (the playback time length) upward/downward by a predetermined ratio, a frame skip request, a frame repeat request, etc., but embodiments of the disclosure are not limited thereto. According to an embodiment, the delay management request generated in the delay management unit 540, such as a request to increase/decrease the playback time length of a playback frame relative to the source frame time length regarding a source frame by a predetermined amount or adjust it (the playback time length) upward/downward by a predetermined ratio, a frame repeat request, etc., may be transmitted to a delay controller 550 described below. According to an embodiment, the delay management request generated in the delay management unit 540, such as a frame skip request, may be transmitted to the transmitter through a communication interface and network.

According to an embodiment, the receiver controller 500 may include the delay controller 550. According to an embodiment, the delay controller 550 may obtain a delay management request from the delay management unit 540. According to an embodiment, the delay controller 550 may perform operations according to the obtained delay management request. According to an embodiment, when the delay controller 550 obtains, e.g., a request to increase/decrease the playback time length of a playback frame relative to the source frame time length regarding a source frame by a predetermined amount or adjust it (the playback time length) upward/downward by a predetermined ratio, it may appropriately increase or decrease the playback time length (v_total_cycle_d) of the playback frames generated in the decoder 520. According to an embodiment, when increasing/decreasing the playback time length of a playback frame relative to the source frame time length regarding a source frame by a predetermined amount or adjusting it (the playback time length) upward/downward by a predetermined ratio for delay amount control, the amount of such increase/decrease or the ratio of upward/downward adjustment may be a value determined according to receiver device characteristics (e.g., display specifications), delay state, etc., and is not limited to specific examples. According to an embodiment, when the delay controller 550 obtains, e.g., a frame repeat request, the delay controller 550 may cause the display of a selected playback frame among the playback frames generated from the decoder 520 and delivered to and played back on the display to be repeated. The determination of which playback frame's display to repeat may be performed according to various criteria and methods.

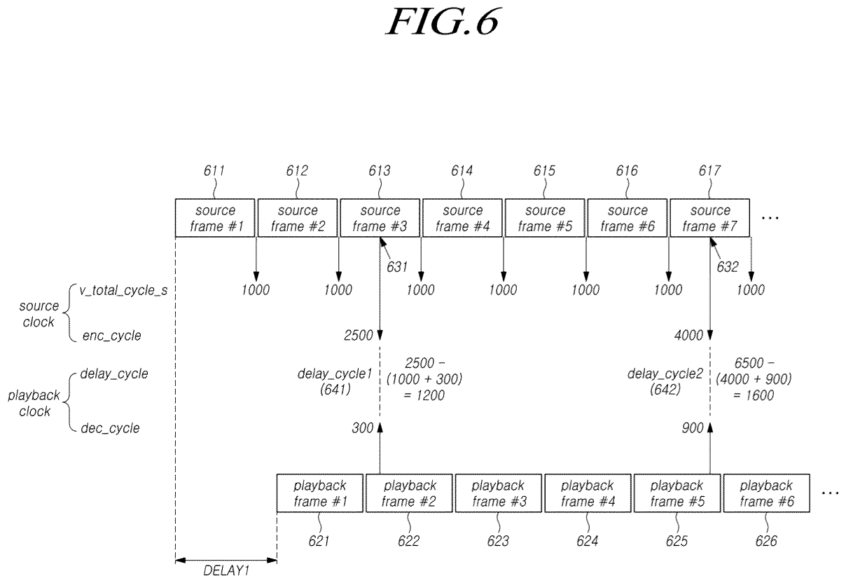

FIG. 6 illustrates an example case of calculating delay amounts of playback frames relative to source frames performed in a receiver according to an embodiment of the disclosure. According to an embodiment, the delay amount calculation illustrated in FIG. 6 may be implemented at least partially by the second controller 210 of the display device 200 of FIG. 2 and/or the receiver controller 500 of FIG. 5. The embodiment of the drawing is merely an example, and the disclosure is not limited to the example embodiment.

As illustrated, the receiver first receives a source frame 611 and generates and plays back the corresponding playback frame 621 after a delay time DELAY1 elapses. As illustrated, the source frame 611 has a total source clock cycle count (v_total_cycle_s) of 1,000. The receiver receives source frames 612, 613, each having a total source clock cycle count (v_total_cycle_s) of 1,000, following the reception of the source frame 611, while generating and playing back a playback frame 622 following the playback frame 621. As illustrated, a reference point 631 is disposed in the middle of the source frame 613. As illustrated, the reference point timing information (enc_cycle) of the reference point 631 of the source frame 613 is 2,500, which may indicate the total number of source clock cycles from the previous reference point (here, the starting point of the source frame 611) to the reference point 631. The frame that has been decoded and playback completed up to the reference point 631 is one playback frame 621, and the duration from the playback start of the most recently decoded playback frame 622 to the reference point 631, i.e., final playback frame duration information (dec_cycle), is 300. Here, calculating the delay amount (delay_cycle1) 641 with respect to the reference point 631 using Equations 1 and 2:

$$delay\_cycle1 ( 641 ) = 2 , 500 - ( 1 , 000 + 300 ) = 1 , 200$$

The receiver also receives source frames 614 to 617 while generating and playing back playback frames 623 to 625. As illustrated, the source frames 614 to 617 each have a total source clock cycle count (v_total_cycle_s) of 1,000, and a reference point 632 is disposed in the middle of the source frame 617. As illustrated, the reference point timing information of the reference point 632 of the source frame 617 is 4,000. According to an embodiment, the reference point timing information 4,000 may indicate the total number of source clock cycles from the previous reference point 631 to the current reference point 632. The frames that have been decoded and playback completed up to the reference point 632 are four playback frames 621 to 624, and the final playback frame duration information is 900. Here, calculating the delay amount (delay_cycle2) 642 with respect to the reference point 632 using Equations 1 and 2:

$$delay\_cycle2 ( 642 ) = ( 2 , 500 + 4 , 000 ) - ( 4 , 000 + 900 ) = 1 , 600$$

In this example, it may be identified, for example by at least one processor of an electronic device, that the delay amount (delay_cycle2) 642 at the reference point 632 increased to 1,600 compared to the delay amount (delay_cycle1) 641 of the reference point 631, which was 1,200. This may show that the decoding and playback delay in the receiver has increased somewhat compared to before.

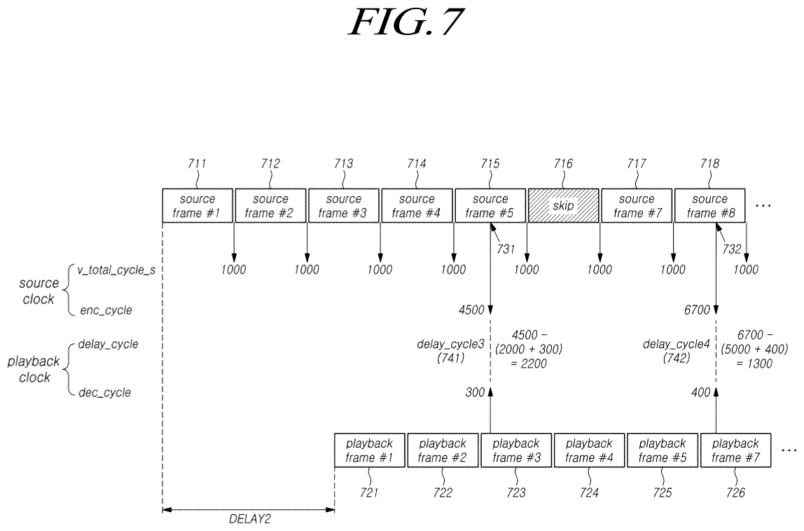

FIG. 7 illustrates an example case of calculating delay amounts of playback frames relative to source frames performed in a receiver according to an embodiment of the disclosure. According to an embodiment, the delay amount calculation illustrated in FIG. 7 may be implemented at least partially by the second controller 210 of the display device 200 of FIG. 2 and/or the receiver controller 500 of FIG. 5. The embodiment of the drawing is merely an example, and the disclosure is not limited to the example embodiment.

As illustrated, the receiver receives source frames 711 to 713 while generating and playing back a playback frame 721 corresponding to the received frame 711 after a delay time DELAY2 elapses. As illustrated, each of the source frames 711 to 713 has a total source clock cycle count (v_total_cycle_s) of 1,000. The receiver receives source frames 714, 715, each having a total source clock cycle count (v_total_cycle_s) of 1,000, following the reception of the source frames 711 to 713, while generating and playing back playback frames 722, 723 following the playback frame 721. As illustrated, a reference point 731 is disposed in the middle of the source frame 715. As illustrated, the reference point timing information (enc_cycle) of the reference point 731 of the source frame 715 is 4,500. In an embodiment, the reference point timing information (enc_cycle) may indicate the total number of source clock cycles from the starting point of the source frame stream (starting point of the source frame 711) to the reference point 731. The frames that have been decoded and playback completed up to the reference point 731 are the playback frames 721, 722, and the duration from the playback start time of the most recently decoded playback frame 723 to the reference point 731, i.e., final playback frame duration information (dec_cycle), is 300. Here, calculating the delay amount (delay_cycle3) 741 with respect to the reference point 731 using Equation 1:

$$delay\_cycle3 ( 741 ) = 4 , 500 - ( 2 , 000 + 300 ) = 2 , 200$$

In an embodiment, the receiver may determine that the delay amount 2,200 is an excessively large value and frame skip is necessary. In an embodiment, the receiver may transmit a frame skip request to the transmitter as feedback data. According to an embodiment, the transmitter that received the frame skip request may determine to skip a source frame 716 that follows the source frame 715. According to an embodiment, as illustrated, the source frame 716 may be skipped and subsequent source frames 717, 718 may be transmitted and received by the receiver. The receiver also receives the source frames 717, 718 while generating and playing back playback frames 724 to 726. As illustrated, the source frames 717, 718 each have a total source clock cycle count (v_total_cycle_s) of 1,000, and a reference point 732 is disposed in the middle of the source frame 718. As illustrated, the reference point timing information of the reference point 732 of the source frame 718 is 6,700. In an embodiment, the reference point timing information (enc_cycle) may indicate the total number of source clock cycles from the starting point of the source frame stream (starting point of the source frame 711) to the reference point 732. The frames that have been decoded and playback completed up to the reference point 732 are five playback frames 721 to 725, and the duration from the playback start time of the most recently decoded playback frame 726 to the reference point 732, i.e., final playback frame duration information, is 400. Here, calculating the delay amount (delay_cycle4) 742 with respect to the reference point 732 using Equation 1:

$$delay\_cycle4 ( 742 ) = 6 , 700 - ( 5 , 000 + 400 ) = 1 , 300$$

In this example, it may be identified, for example by at least one processor of an electronic device, that the delay amount (delay_cycle4) 742 at the reference point 732 decreased to 1,300 after frame skip was performed at the transmitter, compared to the delay amount (delay_cycle3) 741 of the reference point 731, which was 2,200. This may show that the decoding and playback delay in the receiver has decreased somewhat compared to before.

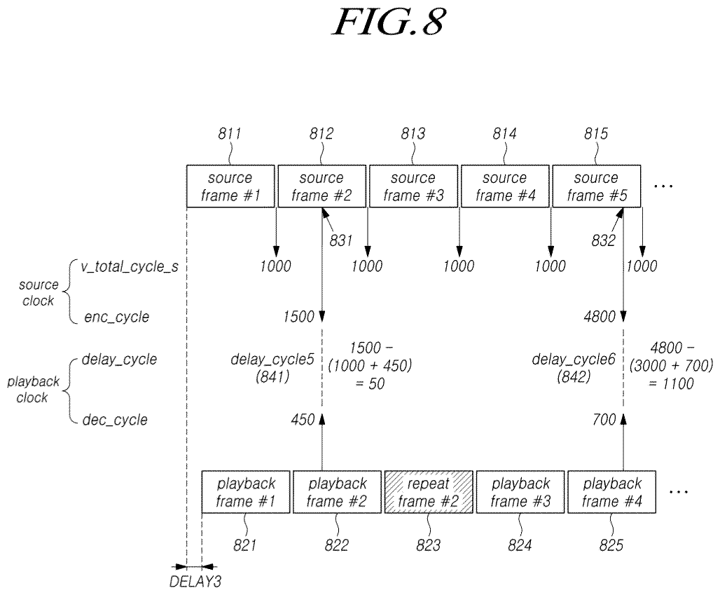

FIG. 8 illustrates an example case of calculating delay amounts of playback frames relative to source frames performed in a receiver according to an embodiment of the disclosure. According to an embodiment, the delay amount calculation illustrated in FIG. 8 may be implemented at least partially by the second controller 210 of the display device 200 of FIG. 2 and/or the receiver controller 500 of FIG. 5. The embodiment of the drawing is merely an example, and the disclosure is not limited to the example embodiment.

As illustrated, the receiver first receives a source frame 811 while generating and playing back a playback frame 821 corresponding to the received frame 811 after a delay time DELAY3 elapses. As illustrated, the source frame 811 has a total source clock cycle count (v_total_cycle_s) of 1,000. The receiver receives a source frame 812 having a total source clock cycle count (v_total_cycle_s) of 1,000 following the reception of the source frame 811, while generating and playing back a playback frame 822 following the playback frame 821. As illustrated, a reference point 831 is disposed in the middle of the source frame 812. As illustrated, the reference point timing information (enc_cycle) of the reference point 831 of the source frame 812 is 1,500. In an embodiment, the reference point timing information (enc_cycle) may indicate the total number of source clock cycles from the starting point of the source frame stream (starting point of the source frame 811) to the reference point 831. The frame that has been decoded and playback completed up to the reference point 831 is one playback frame 821, and the number of playback clock cycles elapsed from the playback start time of the most recently decoded playback frame 822 to the reference point 831 (dec_cycle) is 450. Here, calculating the delay amount (delay_cycle5) 841 with respect to the reference point 831 using Equation 1:

$$delay\_cycle5 ( 841 ) = 1 , 500 - ( 1 , 000 + 450 ) = 50$$

In an embodiment, the receiver may determine that the delay amount 50 is an excessively small value and frame repeat is necessary. In an embodiment, the receiver may generate a frame repeat request. According to an embodiment, based on the frame repeat request, the receiver decoder may repeatedly play back the same playback frame 823 after completing playback of the playback frame 822.

In an embodiment, the receiver performs frame repeat as described above while receiving source frames 813 to 815 and generating and playing back playback frames 824, 825. As illustrated, the source frames 813 to 815 each have a total source clock cycle count (v_total_cycle_s) of 1,000, and a reference point 832 is disposed in the middle of the source frame 815. As illustrated, the reference point timing information of the reference point 832 of the source frame 815 is 4,800. According to an embodiment, the reference point timing information 4,800 may indicate the total number of source clock cycles from the starting point of the source frame stream (starting point of the source frame 811) to the reference point 832. The frames that have been decoded and playback completed up to the reference point 832 are three playback frames 821, 822, 824 (the playback repeated frame 823 is not included), and the number of playback clock cycles elapsed from the playback start time of the most recently decoded playback frame 825 to the reference point 832 is 700. Here, calculating the delay amount (delay_cycle6) 842 with respect to the reference point 832 using Equation 1:

$$delay\_cycle6 ( 842 ) = 4 , 800 - ( 3 , 000 + 700 ) = 1 , 100$$

In this example, it may be identified, for example by at least one processor of an electronic device, that the delay amount (delay_cycle6) 842 at the reference point 832 increased to 1,100 after frame repeat was performed, compared to the delay amount (delay_cycle5) 841 of the reference point 831, which was 50. This may show that the decoding and playback delay in the receiver has increased somewhat compared to before.

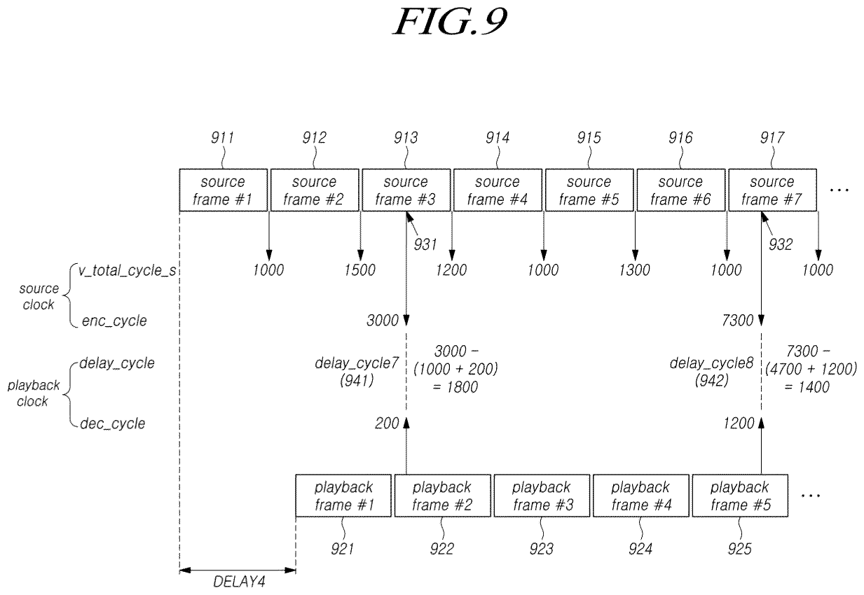

FIG. 9 illustrates an example case of calculating delay amounts of playback frames relative to source frames performed in a receiver according to an embodiment of the disclosure. According to an embodiment, the delay amount calculation illustrated in FIG. 9 may be implemented at least partially by the second controller 210 of the display device 200 of FIG. 2 and/or the receiver controller 500 of FIG. 5. The embodiment of the drawing is merely an example, and the disclosure is not limited to the example embodiment.

As illustrated, the receiver first receives source frames 911, 912 while generating and playing back the corresponding playback frame 921 after a delay time DELAY4 elapses. According to an embodiment, the source frames received by the receiver may be frames generated according to a variable refresh rate (VRR) scheme. As illustrated, the source frame 911 has a total source clock cycle count (v_total_cycle_s) of 1,000, and the source frame 912 has a total source clock cycle count (v_total_cycle_s) of 1,500. The receiver generates and plays back the playback frame 921 corresponding to the source frame 911 after DELAY4 elapses from the initial reception of the source frame 911. The receiver receives a source frame 913 having a total source clock cycle count (v_total_cycle_s) of 1,200 following the reception of the source frames 911, 912, while generating and playing back a playback frame 922 following the playback frame 921. As illustrated, a reference point 931 is disposed in the middle of the source frame 913. As illustrated, the reference point timing information (enc_cycle) of the reference point 931 of the source frame 913 is 3,000. In an embodiment, the reference point timing information (enc_cycle) may indicate the total number of source clock cycles from the starting point of the source frame stream (starting point of the source frame 911) to the reference point 931. The frame that has been decoded and playback completed up to the reference point 931 is one playback frame 921, and the number of playback clock cycles elapsed from the playback start time of the most recently decoded playback frame 922 to the reference point 931 (dec_cycle) is 200. Here, calculating the delay amount (delay_cycle7) 941 with respect to the reference point 931 using Equation 1: delay_cycle7 (941)=3,000−(1,000+200)=1,800

The receiver also receives source frames 914 to 917 while generating and playing back playback frames 923 to 925. As illustrated, the source frame 914 has 1,000, the source frame 915 has 1,300, the source frame 916 has 1,000, and the source frame 917 has 1,000 as a total source clock cycle count (v_total_cycle_s). A reference point 932 is disposed in the middle of the source frame 917. As illustrated, the reference point timing information of the reference point 932 of the source frame 917 is 7,300. According to an embodiment, the reference point timing information 7,300 may indicate the total number of source clock cycles from the starting point of the source frame stream (starting point of the source frame 911) to the reference point 932. The frames that have been decoded and playback completed up to the reference point 932 are four playback frames 921 to 924, and the number of playback clock cycles elapsed from the playback start time of the most recently decoded playback frame 925 to the reference point 932 is 1,200. Here, calculating the delay amount (delay_cycle8) 942 with respect to the reference point 932 using Equation 1: delay_cycle8 (942)=7,300−((1,000+1,500+1,200+1000)+1,200)=1,400

In this example, it may be identified, for example by at least one processor of an electronic device, that the delay amount (delay_cycle8) 942 at the reference point 932 decreased to 1,400 compared to the delay amount (delay_cycle7) 941 of the reference point 931, which was 1,800. This may show that the decoding and playback delay in the receiver has decreased somewhat compared to before.

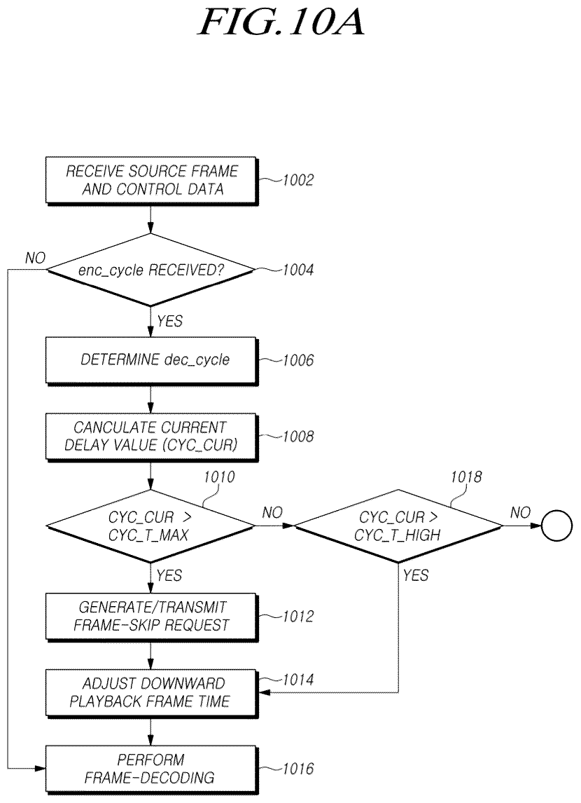

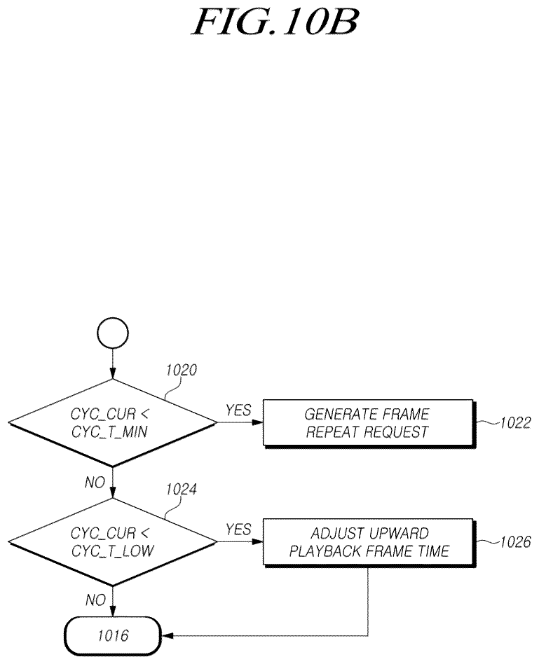

FIGS. 10A and 10B are flowcharts of data processing of a receiver according to an embodiment of the disclosure. According to an embodiment, the data processing disclosed in FIGS. 10A and 10B may be implemented at least partially by the second controller 210 of the display device 200 of FIG. 2 and/or the receiver controller 500 of FIG. 5.

According to an embodiment, in operation 1002, source frames and related control data transmitted through a network may be received. In an embodiment, the received control data may include information such as the source frame time length corresponding to each source frame and the reference point timing information (enc_cycle) corresponding to each time reference point.

In operation 1004, it may be determined, for example by at least one processor of an electronic device, whether the reference point timing information (enc_cycle) corresponding to a time reference point disposed in any source frame among the source frames has been received. If it is determined, for example by at least one processor of an electronic device, in operation 1004 that the reference point timing information (enc_cycle) has been received, the procedure may proceed to operation 1006 to determine the final playback frame duration information (dec_cycle). Then, in operation 1008, a decoding and playback delay value (CYC_CUR) corresponding to the reference point may be calculated (or determined). According to an embodiment, the decoding and playback delay value (CYC_CUR) may be calculated (or determined) according to, e.g., Equations 1 and 2 described above.

According to an embodiment, in operation 1010, it may be determined, for example by at least one processor of an electronic device, whether the calculated (or determined) decoding and playback delay value (CYC_CUR) is a value greater than a first parameter (CYC_T_MAX). In an example, the first parameter (CYC_T_MAX) may be a predetermined target maximum delay time value. If it is determined, for example by at least one processor of an electronic device, in operation 1010 that the delay value (CYC_CUR) is a value greater than the first parameter (CYC_T_MAX) (i.e., when the delay value exceeds a predetermined target maximum delay time value), the procedure may proceed to operation 1012 to generate a frame skip request, and the generated frame skip request may be transmitted to the transmitter through a network as feedback data. In operation 1014, the playback time length of a playback frame relative to the source frame time length to be used when decoding a source frame may be decreased by a predetermined amount or adjusted downward by a predetermined ratio. As described above, how much to decrease the playback time length may be a predetermined value according to receiver device characteristics (e.g., display specifications), delay state, etc., and is not limited to specific examples. In an embodiment, when determining that the delay value (CYC_CUR) is a value greater than the first parameter (CYC_T_MAX), it may be considered, for example by at least one processor of an electronic device, that the delay amount is excessively excessive, and two-stage delay control may be performed by downwardly adjusting the playback time length of the playback frames together with a frame skip request. After the playback time length of the playback frame is adjusted downward, in operation 1016, decoding of the source frame may be performed according to the adjustment.

If it is determined, for example by at least one processor of an electronic device, in operation 1010 that the delay value (CYC_CUR) is less than or equal to the first parameter (CYC_T_MAX), the procedure may proceed to operation 1018 to determine whether the delay value (CYC_CUR) is a value greater than a second parameter (CYC_T_HIGH). In an example, the second parameter (CYC_T_HIGH) may be a predetermined target upper delay time value. When it is determined, for example by at least one processor of an electronic device, in operation 1018 that the delay value (CYC_CUR) is a value greater than the second parameter (CYC_T_HIGH), the procedure may proceed to operation 1014 to decrease the playback time length of a playback frame relative to the source frame time length to be used when decoding a source frame by a predetermined amount or adjust it (the playback time length) downward by a predetermined ratio. In an embodiment, when determining that the delay value (CYC_CUR) is not greater than the first parameter (CYC_T_MAX) but is a value greater than the second parameter (CYC_T_HIGH), it may be considered, for example by at least one processor of an electronic device, that the delay amount is still high although not excessively excessive, and one-stage delay control may be performed by downwardly adjusting the playback time length of the playback frames. After the playback time length of the playback frame is adjusted downward, in operation 1016, decoding of the source frame may be performed based on the adjustment result.

If it is determined, for example by at least one processor of an electronic device, in operation 1018 that the delay value (CYC_CUR) is a value less than or equal to the second parameter (CYC_T_HIGH), the procedure may proceed to operation 1020 to determine whether the calculated (or determined) decoding/playback delay value (delay_cycle) is a value less than a third parameter (CYC_T_MIN). In an example, the third parameter (CYC_T_MIN) may be a predetermined target minimum delay time value. If it is determined, for example by at least one processor of an electronic device, in operation 1020 that the delay value (CYC_CUR) is a value less than the third parameter (CYC_T_MIN), the procedure may proceed to operation 1022 and a frame repeat request may be generated. In an embodiment, when determining that the delay value (CYC_CUR) is a value less than the third parameter (CYC_T_MIN), it may be considered, for example by at least one processor of an electronic device, that the delay amount is insufficient, and delay control of generating a frame repeat request may be performed. In an embodiment, the insufficiency of the delay amount may be resolved while frame playback repetition is performed according to the frame repeat request. In this embodiment, one-stage delay control of generating a frame repeat request is performed in the case of such insufficient delay, but embodiments of the disclosure are not limited thereto. In another embodiment, when determining that the delay is excessively insufficient, two-stage delay control may be performed by upwardly adjusting the playback time length of the playback frames relative to the time length of the source frames together with a frame repeat request.

If it is determined, for example by at least one processor of an electronic device, in operation 1020 that the delay value (CYC_CUR) is not a value less than the third parameter (CYC_T_MIN), the procedure may proceed to operation 1024 to determine whether the delay value (CYC_CUR) is a value less than a fourth parameter (CYC_T_LOW). In an example, the fourth parameter (CYC_T_LOW) may be a predetermined target lower delay time value. If it is determined, for example by at least one processor of an electronic device, in operation 1024 that the delay value (CYC_CUR) is a value less than the fourth parameter (CYC_T_LOW), the procedure may proceed to operation 1026. In operation 1026, the playback time length of a playback frame relative to the source frame time length to be used when decoding a source frame may be increased by a predetermined amount or adjusted upward by a predetermined ratio. In an embodiment, when determining that the delay value (CYC_CUR) is not lower than the third parameter (CYC_T_MIN) but is a value lower than the fourth parameter (CYC_T_LOW), it may be considered, for example by at least one processor of an electronic device, that the delay amount is somewhat low, and delay control may be performed by upwardly adjusting the playback time length of the playback frames. After the time length of the playback frame is adjusted upward, the procedure may proceed to operation 1016 to perform decoding of the source frame based on the adjustment result.

According to an aspect of the disclosure, an electronic device includes: a communication interface; a display; at least one processor; and memory storing instructions, wherein the instructions, when executed by the at least one processor individually or collectively, cause the electronic device to: obtain, through the communication interface, a series of source frames encoded, each source frame time length of each of the source frames, and first reference point timing information for a first reference point defined on a first source frame among the series of source frames; generate playback frames for reproduction through the display by decoding the source frames; determine a playback delay value based on the first reference point timing information and each source frame time length of each of the source frames corresponding to playback frames that complete playback prior to obtaining the first reference point timing information; and perform delay control based on the playback delay value.

According to an aspect of the disclosure, each source frame time length is a total number of clock cycles allocated to a corresponding source frame during encoding, and wherein the first reference point timing information indicates a temporal position of the first reference point on the series of source frames.

According to an aspect of the disclosure, the first reference point timing information indicates a total number of clock cycles from a start of an initial source frame among the series of source frames to the first reference point, and wherein the instructions, when executed by the at least one processor individually or collectively, further cause the electronic device to determine the total number of clock cycles during encoding.

According to an aspect of the disclosure, the first reference point timing information indicates a total number of clock cycles from another reference point that existed immediately before the first reference point to the first reference point, and wherein the instructions, when executed by the at least one processor individually or collectively, further cause the electronic device to determine the total number of clock cycles during encoding.

According to an aspect of the disclosure, the instructions, when executed by the at least one processor individually or collectively, further cause the electronic device to determine the playback delay value further based on elapsed time information from a playback start of a most recently decoded playback frame with respect to an obtaining time of the first reference point timing information to the obtaining time of the first reference point timing information.

According to an aspect of the disclosure, the instructions, when executed by the at least one processor individually or collectively, further cause the electronic device to: obtain a first value indicating a temporal position of the first reference point on the series of source frames, based on the first reference point timing information; obtain a second value by summing a total sum of each source frame time length of each of the source frames corresponding to playback frames that complete playback prior to obtaining the first reference point timing information and elapsed time from a playback start of a playback frame to an obtaining time of the first reference point timing information, wherein the playback frame is most recently decoded with respect to the obtaining time of the first reference point timing information; and determine the playback delay value as a result of subtracting the second value from the first value.

According to an aspect of the disclosure, the instructions, when executed by the at least one processor individually or collectively, further cause the electronic device to periodically define one or more reference points on the series of source frames based on a predetermined criterion.

According to an aspect of the disclosure, the delay control includes at least one of: playback time adjustment for a playback frame, generation of a skip request for one or more source frames, or repeated playback of one or more playback frames.

According to an aspect of the disclosure, the memory further stores one or more parameters, and wherein the instructions, when executed by the at least one processor individually or collectively, further cause the electronic device to perform the delay control based on a comparison of the playback delay value and the one or more parameters.

According to an aspect of the disclosure, the one or more parameters correspond to a target maximum delay time, a target upper delay time, a target lower delay time, and a target minimum delay time, and wherein, based on the playback delay value being greater than the target maximum delay time, the delay control includes at least one of downward adjustment of playback time for the playback frame and generation of the skip request for the one or more source frames.

According to an aspect of the disclosure, based on the playback delay value being between the target maximum delay time and the target upper delay time, the delay control includes downward adjustment of playback time for a playback frame.

According to an aspect of the disclosure, based on the playback delay value being less than the target minimum delay time, the delay control includes the repeated playback of one or more playback frames.

According to an aspect of the disclosure, based on the playback delay value being between the target minimum delay time and the target lower delay time, the delay control includes upward adjustment of playback time for the playback frame.

According to an aspect of the disclosure, a display system includes: a video transmission device including: an encoder configured to encode video information into a series of source frames; a time length generation circuit configured to generate each source frame time length information regarding each of the source frames; a reference point timing information generation circuit configured to generate first reference point timing information corresponding to a first reference point of a first source frame among the series of source frames; and a first communication interface configured to transmit stream data including the series of source frames, each source frame time length information regarding each of the source frames, and the first reference point timing information; a video reception device including: a second communication interface configured to receive the stream data; a decoder configured to generate a series of playback frames from the source frames of the stream data; a display configured to reproduce the series of playback frames; a delay amount determination circuit configured to determine a playback delay value based on the first reference point timing information and each source frame time length of each of the source frames corresponding to playback frames that complete playback by the display prior to obtaining the first reference point timing information; and a delay control circuit configured to perform delay control based on the playback delay value.

The delay amount determination circuit is further configured to determine the playback delay value further based on elapsed time information from a playback start of a playback frame to an obtaining time of the first reference point timing information, and wherein the playback frame is most recently generated by the decoder with respect to the obtaining time of the first reference point timing information.

The delay amount determination circuit is further configured to: obtain a first value indicating a temporal position of the first reference point on the series of source frames based on the first reference point timing information; obtain a second value by summing a total sum of each source frame time length of each of the source frames corresponding to playback frames that complete playback by the display and elapsed time from a playback start of a playback frame to an obtaining time of the first reference point timing information, wherein the playback frame is most recently generated by the decoder with respect to the obtaining time of the first reference point timing information; and calculate (or determine) the playback delay value as a result of subtracting the second value from the first value.

According to an aspect of the disclosure, the video transmission device is configured to operate based on a source clock, and wherein the first reference point timing information indicates a total number of source clock cycles from a start of an initial source frame among the series of source frames to the first reference point.

According to an aspect of the disclosure, the video transmission device is configured to operate based on a source clock, and wherein the first reference point timing information indicates a total number of source clock cycles from another reference point that existed immediately before the first reference point to the first reference point.

According to an aspect of the disclosure, the video reception device further includes memory storing one or more parameters, and wherein the delay control circuit is configured to perform the delay control based on a comparison of the playback delay value and the one or more parameters.

According to an aspect of the disclosure, the delay control by the delay control circuit includes at least one of upward adjustment of playback time for a playback frame, downward adjustment of playback time for the playback frame, generation and transmission of a skip request for one or more source frames to the video transmission device, or repeated playback of one or more playback frames.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, or a home appliance. According to an embodiment of the disclosure, the electronic devices are not limited to those described above.

One or more embodiments of the disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in one or more embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the display system and the electronic device described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising,
a communication interface;
a display;
at least one processor; and
memory comprising at least one storage medium storing instructions,
wherein the instructions, when executed by the at least one processor individually or collectively, cause the electronic device to:
obtain, through the communication interface, a series of source frames encoded, each source frame time length of each of the source frames, and first reference point timing information for a first reference point defined on a first source frame among the series of source frames;
generate playback frames for reproduction through the display by decoding the source frames;
determine a playback delay value based on the first reference point timing information and each source frame time length of each of the source frames corresponding to playback frames that complete playback prior to obtaining the first reference point timing information; and
perform delay control based on the playback delay value.

2. The electronic device of claim 1, wherein each source frame time length is a total number of clock cycles allocated to a corresponding source frame during encoding, and
wherein the first reference point timing information indicates a temporal position of the first reference point on the series of source frames.

3. The electronic device of claim 1, wherein the first reference point timing information indicates a total number of clock cycles from a start of an initial source frame among the series of source frames to the first reference point, and
wherein the instructions, when executed by the at least one processor individually or collectively, further cause the electronic device to determine the total number of clock cycles during encoding.

4. The electronic device of claim 1, wherein the first reference point timing information indicates a total number of clock cycles from another reference point that existed immediately before the first reference point to the first reference point, and
wherein the instructions, when executed by the at least one processor individually or collectively, further cause the electronic device to determine the total number of clock cycles during encoding.

5. The electronic device of claim 1, wherein the instructions, when executed by the at least one processor individually or collectively, further cause the electronic device to determine the playback delay value further based on elapsed time information from a playback start of a most recently decoded playback frame with respect to an obtaining time of the first reference point timing information to the obtaining time of the first reference point timing information.

6. The electronic device of claim 1, wherein the instructions, when executed by the at least one processor individually or collectively, further cause the electronic device to:
obtain a first value indicating a temporal position of the first reference point on the series of source frames, based on the first reference point timing information;
obtain a second value by summing a total sum of each source frame time length of each of the source frames corresponding to playback frames that complete playback prior to obtaining the first reference point timing information and elapsed time from a playback start of a playback frame to an obtaining time of the first reference point timing information, wherein the playback frame is most recently decoded with respect to the obtaining time of the first reference point timing information; and
determine the playback delay value as a result of subtracting the second value from the first value.

7. The electronic device of claim 1, wherein the instructions, when executed by the at least one processor individually or collectively, further cause the electronic device to periodically define one or more reference points on the series of source frames based on a predetermined criterion.

8. The electronic device of claim 1, wherein the delay control comprises at least one of: playback time adjustment for a playback frame, generation of a skip request for one or more source frames, or repeated playback of one or more playback frames.

9. The electronic device of claim 8, wherein the memory further stores one or more parameters, and
wherein the instructions, when executed by the at least one processor individually or collectively, further cause the electronic device to perform the delay control based on a comparison of the playback delay value and the one or more parameters.

10. The electronic device of claim 9, wherein the one or more parameters correspond to a target maximum delay time, a target upper delay time, a target lower delay time, and a target minimum delay time, and
wherein, based on the playback delay value being greater than the target maximum delay time, the delay control comprises at least one of downward adjustment of playback time for the playback frame and generation of the skip request for the one or more source frames.

11. The electronic device of claim 10, wherein, based on the playback delay value being between the target maximum delay time and the target upper delay time, the delay control comprises downward adjustment of playback time for a playback frame.

12. The electronic device of claim 10, wherein, based on the playback delay value being less than the target minimum delay time, the delay control comprises the repeated playback of one or more playback frames.

13. The electronic device of claim 10, wherein, based on the playback delay value being between the target minimum delay time and the target lower delay time, the delay control comprises upward adjustment of playback time for the playback frame.

14. A display system comprising:
a video transmission device comprising:
an encoder configured to encode video information into a series of source frames;
a time length generation circuit configured to generate each source frame time length information regarding each of the source frames;
a reference point timing information generation circuit configured to generate first reference point timing information corresponding to a first reference point of a first source frame among the series of source frames; and
a first communication interface configured to transmit stream data comprising the series of source frames, each source frame time length information regarding each of the source frames, and the first reference point timing information;
a video reception device comprising:
a second communication interface configured to receive the stream data;
a decoder configured to generate a series of playback frames from the source frames of the stream data;
a display configured to reproduce the series of playback frames;
a delay amount determination circuit configured to determine a playback delay value based on the first reference point timing information and each source frame time length of each of the source frames corresponding to playback frames that complete playback by the display prior to obtaining the first reference point timing information; and
a delay control circuit configured to perform delay control based on the playback delay value.

15. The display system of claim 14, wherein the delay amount determination circuit is further configured to determine the playback delay value further based on elapsed time information from a playback start of a playback frame to an obtaining time of the first reference point timing information, and
wherein the playback frame is most recently generated by the decoder with respect to the obtaining time of the first reference point timing information.

16. The display system of claim 14, wherein the delay amount determination circuit is further configured to:
obtain a first value indicating a temporal position of the first reference point on the series of source frames based on the first reference point timing information;
obtain a second value by summing a total sum of each source frame time length of each of the source frames corresponding to playback frames that complete playback by the display and elapsed time from a playback start of a playback frame to an obtaining time of the first reference point timing information, wherein the playback frame is most recently generated by the decoder with respect to the obtaining time of the first reference point timing information; and
determine the playback delay value as a result of subtracting the second value from the first value.

17. The display system of claim 14, wherein the video transmission device is configured to operate based on a source clock, and
wherein the first reference point timing information indicates a total number of source clock cycles from a start of an initial source frame among the series of source frames to the first reference point.

18. The display system of claim 14, wherein the video transmission device is configured to operate based on a source clock, and
wherein the first reference point timing information indicates a total number of source clock cycles from another reference point that existed immediately before the first reference point to the first reference point.

19. The display system of claim 14, wherein the video reception device further comprises memory storing one or more parameters, and
wherein the delay control circuit is configured to perform the delay control based on a comparison of the playback delay value and the one or more parameters.

20. The display system of claim 19, wherein the delay control by the delay control circuit comprises at least one of upward adjustment of playback time for a playback frame, downward adjustment of playback time for the playback frame, generation and transmission of a skip request for one or more source frames to the video transmission device, or repeated playback of one or more playback frames.
